(19) United States
(12) Patent Application Publication
(10) Pub. No.: US 2004/0006665 A1
(43) Pub. Date: Jan. 8, 2004

(54) Methods and structure for hiding DRAM bank precharge and activate latency by issuing apriori bank state transition information

(76) Inventor: Robert W. Moss, Longmont, CO (US)

Correspondence Address: LSI LOGIC CORPORATION, 1621 BARBER LANE, MS: D-106 LEGAL, MILPITAS, CA, 95035, US

(21) Appl. No.: 10/188,881

(22) Filed: Jul. 2, 2002

(51) Int. Cl. G06F 12/00

(52) U.S. Cl. 711/5

(57) ABSTRACT

In a system having multiple master devices coupled to a shared resource, methods and structure for generating apriori information by an arbiter of the shared resource to enable the shared resource to better utilize the bandwidth of the shared resource. A first preferred embodiment of the invention provides an arbiter coupling a shared memory controller to a plurality of master devices generating memory requests for the memory controller. The arbiter preferably detects memory requests from another master device to detect when a next request is directed to a different bank of memory. Apriori information indicative of such a change in banks is sent to the memory controller in advance of the memory request that will require the change of banks. This apriori information enables the memory controller to control the sequence of commands applied to the memory subsystem to optimize utilization of the memory subsystem and hence improve system performance.

### RELATED PATENTS

This patent is related to co-pending, commonly owned U.S. patent application Ser. No. ______ (01-271), entitled METHODS AND STRUCTURE FOR SEQUENCING OF ACTIVATION COMMANDS IN A HIGH-PERFORMANCE DDR SDRAM MEMORY CONTROLLER, filed ______ and hereby incorporated by reference (hereinafter referred to as the “sibling” patent application). This patent is also related to co-pending, commonly owned U.S. patent application Ser. No. ______ (01-830), entitled METHODS AND STRUCTURE FOR USING A MEMORY MODEL FOR EFFICIENT ARBITRATION, filed ______ and hereby incorporated by reference (hereinafter referred to as the “second sibling” patent application).

### BACKGROUND OF THE INVENTION

1. Field of the Invention

The present invention relates to systems using high-performance memory controllers and more specifically relates to methods and structure for providing apriori state information that permits a high-performance DRAM controller to sequence DRAM bank precharge and activate commands to improve system performance.

2. Discussion of Related Art

In present day digital electronic systems, high performance memory subsystems are comprised of a plurality of memory chip devices each having a plurality of banks within the device. High-performance memory chip devices typically provide for burst modes of access to help optimize bandwidth utilization of the memory device by an associated master or controlling device. Generally a “burst” operation is one where a single read or write command may access a sequence of locations within the memory chip device in rapid succession. Multiple banks within such memory chip devices may be operated in a variety of parallel fashions to overlap processing in one bank of the memory with processing in other banks of the memory. Such features are well-known in the art to improve performance of memory subsystems.

In general, present-day high-performance memory subsystems utilize a memory controller device between the master devices intended to utilize the memory subsystem (i.e., a general purpose processor or other special-purpose processing devices) and the memory subsystem. Such a memory controller device is intended to shield the master device from details of a controlling the memory chip devices and the memory banks to achieve optimal memory subsystem performance. For example, such memory controller devices assume responsibility for controlling the memory chip devices to best utilize burst mode operations and further controlling the multiple banks of memory to permit significant overlap in processing memory operations among the plurality of banks.

It is generally known in the art that a slave device (such as a memory controller) may be multi-ported in that it has multiple ports each of which may be coupled to a bus that, in turn, has one or more master devices coupled thereto. In the context of such a multi-ported memory controller a requesting “master device” may be understood to be a bus coupled to a port of the controller rather than a particular device on that bus. “Master device” as used herein should therefore be understood to encompass both a discrete master device coupled to a memory controller as well as a bus coupled to a port of a multi-ported memory controller.

A number of current high-performance memory subsystems utilize SDRAM (synchronous dynamic random access memory) memory chip devices as well as variants of such SDRAM devices that provided double data rate operations (i.e., DDR SDRAMs). As used herein, “SDRAM” refers to both standard SDRAM memory devices and DDR SDRAM memory devices. Features of the present invention as discussed further herein below are applicable to both types of SDRAM devices as well as other memory chip devices.

As is known in the art, industry standard specifications provide for a command structure in accessing SDRAM devices. For example, JEDEC standard JESD79 provides a standardized specification for commands used in accessing DDR SDRAM devices (published by the JEDEC Solid State Technology Association in June of 2000 and available publicly at www.jedec.org). Similar command structures are defined for access to all SDRAM devices as well as other types of memory chip devices. A memory controller device responds to memory operations requested by the master device and translates the request into appropriate SDRAM commands in an appropriate sequence to store or retrieve the requested data to or from the memory chip devices. The memory controller device therefore assumes responsibility for optimal use of available bandwidth for the memory devices as regards the sequencing of commands it is processing.

Addressing a location (or sequence of locations) in a memory chip device involves selecting a column and a row (also referred to as a “page”). The standardized command structure for accessing SDRAM devices (and other memory chip devices) requires that the desired page or row of a memory device must be open or active prior to reading or writing data from or to a memory location in that page. An “activate” command is typically used to specify the page or row to be opened prior to issuance of a read or write command accessing locations within that page. Typically, the activate command also specifies which bank of a multibank memory subsystem is to be activated. An active or open page is closed or made inactive by a “precharge” operation. A typical sequence therefore involves closing a previously open to page with a precharge command, opening a next page to be accessed with an activate command, and then issuing appropriate read or write commands to retrieve or store the desired data from or to memory locations in the open page.

The synchronous nature of SDRAM devices generally requires that some command be present on the input signal paths of the memory chip devices at each clock pulse applied to the memory chip device. When a read or write command is issued that requests a burst of a number of sequential locations, one or more clock cycles may be applied to the memory chip device before another read or write operation is permitted. To assure that some command is applied to the input of the memory chip device, typical memory controller devices generate nop commands to fill the otherwise unused command sequences during burst cycles. Other sequences of commands also require application of nop commands during latency periods awaiting completion of an earlier issued command to the memory chip device. For example, there is typically a latency following issuance of an activate command before the specified page is open and ready for a read or write command. Such latency periods are typically filled with nop commands by memory controller devices.

It is a constant problem to improve memory bandwidth utilization to thereby improve overall system performance for an associated system. Methods and structures that improve memory subsystem bandwidth utilization are therefore desirable. In particular, it is desirable to reduce the latency between activation of a page of memory and access to the opened page.

The sibling patent application teaches structures and methods for sequencing the commands applied by the memory controller to the memory subsystem banks to reduce latency and thereby improve system performance. Such a memory controller requires the master devices to indicate the need for a bank activation in advance of the actual need to utilize the bank. Such information is required by the memory controller to enable it to detect appropriate command cycles in which SDRAM commands may be inserted to appropriately sequence the commands to improve memory subsystem utilization. It is a general problem to enable any arbitrary master device coupled to the memory controller to provide such information to the memory controller.

In practice, it is common for multiple master devices to be coupled to the memory subsystem through the memory controller. It is generally known in the art to use an arbiter structure to arbitrate among a plurality of such master devices all substantially simultaneously requesting access to the shared memory resource. An arbiter receives a request signal from each master device and, in due course, grants to each requesting master device temporary exclusive access to the shared memory subsystem (via the memory controller). While the master device has temporary exclusive access, the master device issues instructions (also referred to herein as commands) to the memory controller to read and write information in the memory subsystem as required.

In particular, a master device may issue a “precharge and activate” command to start operations in a new bank of memory—i.e., a different bank than was last in use by the same or another master device. The precharge and activate commands created by the memory controller are then usually followed by read or write commands (including read or write burst commands).

The sibling patent application suggests a single, unspecified, master device generates the “precharge and activate” command in advance of the need for the corresponding bank to permit the enhanced memory controller to sequence commands sent from the memory controller to the memory subsystem. Where multiple master devices may be coupled to the memory controller, it is a problem for an arbiter to coordinate the issuance of commands between the multiple master devices and a memory controller to permit the memory controller to optimize memory bank activity.

It is evident from the above discussion that a need exists for an improved structure and method of operation of an arbiter coupling multiple master devices to a shared resource to permit the shared resource to effectively optimize utilization of the resource. In particular, a need exists for an improved arbiter and method of operation to send memory bank precharge and activate commands in advance of the need to utilize the corresponding bank.

### SUMMARY OF THE INVENTION

The present invention solves the above and other problems, thereby advancing the state of useful arts, by providing methods and structure for an arbiter to generate apriori information regarding utilization of the shared resource. The generated apriori information is forwarded to the shared resource to permit the shared resource to optimize utilization of the resource.

Still more specifically, one exemplary preferred embodiment of the present invention provides that the improved arbiter receives memory controller command information from multiple master devices and forwards the commands to a shared memory controller. When the arbiter senses pending activation of a different memory bank by another master device, the precharge and activation requests associated therewith are forwarded in advance of the pending need for the bank by the other master device. This apriori information enables the memory controller to improve utilization of the memory devices by overlapping precharge and activate latency with ongoing burst operations in other banks (as discussed in the sibling patent application).

A first feature of the invention therefore provides a method operable in an arbiter coupling a plurality of master devices to a memory controller controlling multiple banks of memory, the method comprising: detecting a pending request from a first master device to issue first commands to the memory controller; generating apriori information regarding the first commands; and applying the apriori information to the memory controller in advance of applying the first commands to the memory controller to enable the memory controller to prepare for future receipt of the first commands.

Another aspect of the invention further provides that the step of applying comprises the step of: applying the apriori information in conjunction with application of other commands to the memory controller.

Another aspect of the invention further provides that the step of generating comprises the step of: generating apriori information indicating a change in presently accessed memory bank when the first commands relate to a first bank of memory and that the other commands relate to a different bank of memory.

Another aspect of the invention further provides for: delaying application of the first commands to permit the memory controller to prepare the first bank; and applying the other commands related to the different banks to the memory controller during the period of delay.

Another aspect of the invention further provides that the step of generating apriori information indicating a change in presently accessed memory bank comprises the steps of: generating a precharge command for the first bank of memory; and applying the precharge command in advance of application of the first commands.

Another feature of the invention provides a system operable in an arbiter coupling a plurality of master devices to a memory controller controlling multiple banks of memory, the system comprising: means for detecting a pending request from a first master device to issue first commands to the memory controller; means for generating apriori information regarding the first commands; and means for applying the apriori information to the memory controller in advance of applying the first commands to the memory controller to enable the memory controller to prepare for future receipt of the first commands.

Another aspect of the invention further provides that the means for applying comprises: means for applying the apriori information in conjunction with application of other commands to the memory controller.

Another aspect of the invention further provides that the means for generating comprises: means for generating apriori information indicating a change in presently accessed memory bank when the first commands relate to a first bank of memory and that the other commands relate to a different bank of memory.

Another aspect of the invention further provides for: means for delaying application of the first commands to permit the memory controller to prepare the first bank; and means for applying the other commands related to the different banks to the memory controller during the period of delay.

Another aspect of the invention further provides that the means for generating apriori information indicating a change in presently accessed memory bank comprises: means for generating a precharge command for the first bank of memory; and applying the precharge command in advance of application of the first commands.

### BRIEF DESCRIPTION OF THE DRAWINGS

FIG. 1 is a block diagram of a system using the improved arbitration features of the present invention.

FIG. 2 is a flowchart broadly describing a method of the present invention to generate apriori information to enable a shared resource to better optimize its utilization.

FIG. 3 is a variant of the flowchart of FIG. 2 specifically applied to the particular application of the features of the present invention to a shared memory controller.

FIG. 4 is a block diagram of an exemplary embodiment of the improved arbitration features of the present invention.

FIG. 5 is a sample timing diagram describing operation of the exemplary circuits of FIG. 4 in accordance with the present invention.

### DETAILED DESCRIPTION OF THE PREFERRED EMBODIMENTS

While the invention is susceptible to various modifications and alternative forms, a specific embodiment thereof has been shown by way of example in the drawings and will herein be described in detail. It should be understood, however, that it is not intended to limit the invention to the particular form disclosed, but on the contrary, the invention is to cover all modifications, equivalents, and alternatives falling within the spirit and scope of the invention as defined by the appended claims.

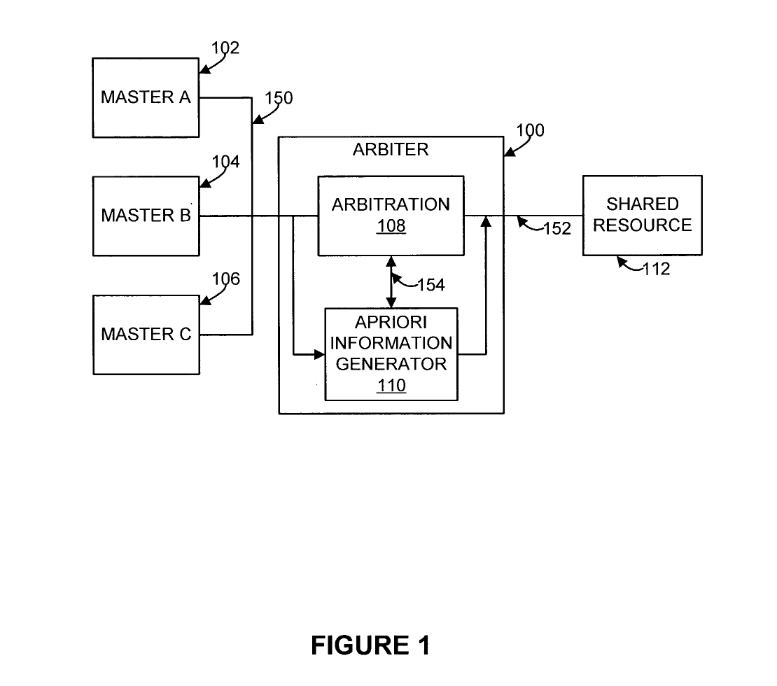

FIG. 1 is a block diagram of a system with an improved arbiter 100 generating apriori information 110 for use by a shared resource 112 to improve utilization of the shared resource. In general, arbiter 100 receives requests for access to the shared resource 112 from any of multiple master devices 102, 104 or 106. Requests for such access and grant signals associated with such requests are exchanged via path 150 between arbiter 100 and master devices 102, 104 and 106. Arbiter 100 includes standard arbitration element 108 to select on-line requesting master devices 102 through 106 to grant requested temporary exclusive access to the shared resource 112. Arbitration element 108 applies well-known, standard arbitration techniques to select among the plurality of master devices including, for example, round-robin and priority-based arbitration techniques.

Those of ordinary skill in the art will readily recognize that master devices 102 through 106 may be any of several common types of master devices coupled to common interface bus path 150. For example, master devices 102 through 106 may be general or special purpose processors, intelligent I/O coprocessors, DMA coprocessors and other devices capable of initiating requests for interaction with the shared resource 112. Similarly, those of ordinary skill in the art will readily recognize that shared resource 112 represents a wide variety of components shared by the master devices. For example, shared resource 112 may simply be a common interface bus shared by the multiple master devices.

In an exemplary preferred embodiment, where master devices 102 through 106 communicate with a memory subsystem, shared resource 112 preferably represents a memory controller of the shared memory subsystem. In particular, memory controller 112 preferably controls multiple banks of memory such that each bank is activated as a request is directed thereto and deactivated as required. Master devices 102 through 106 therefore represent general or special purpose processors, DMA controllers and intelligent I/O peripheral controllers that require access to one or more banks of the multiple banks of memory controlled by the shared memory controller.

In this preferred embodiment, as noted above, it is advantageous for the shared memory controller 112 to receive apriori information indicative of upcoming changes in the active bank of memory controlled by the memory controller. Apriori information generator 110 master monitors request and grant information applied to path 150 and exchanges information with arbitration element 108 via path 154 to generate such apriori information. In particular, apriori information generator 110 generates memory bank precharge and activate commands for application to bus 152 in conjunction with memory request commands generated by master devices 102 through 106 and applied to path 152 through arbitration element 108 and path 150.

Those of ordinary skill in the art will readily recognize that these features of the present invention may be advantageously applied to a number of system and bus architectures. For example, the devices and buses depicted in FIG. 1 may be compliant with the AMBA AHB standards as well as other well-known commercial bus architectures such as PCI. Generally, the features of the present invention are advantageously applied where a shared resource coupled to multiple master devices would benefit from apriori information regarding future bus transactions to permit optimization of utilization of the shared resource. The exemplary preferred embodiment wherein the shared resource is a memory controller is therefore intended as one common example of such a beneficial application.

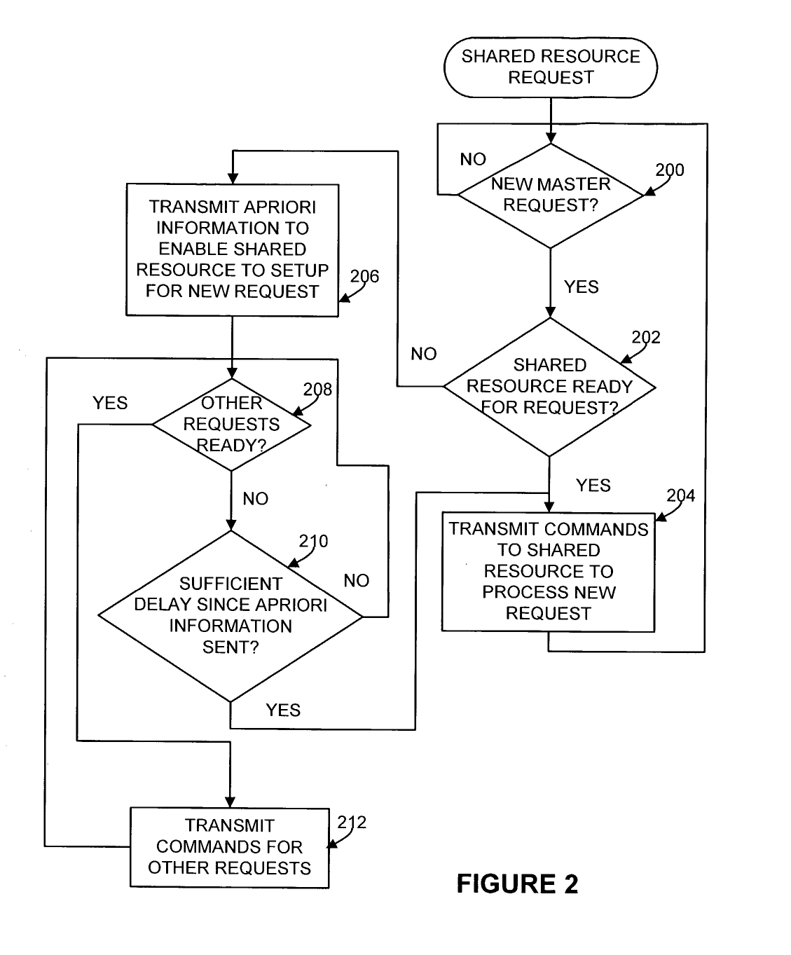

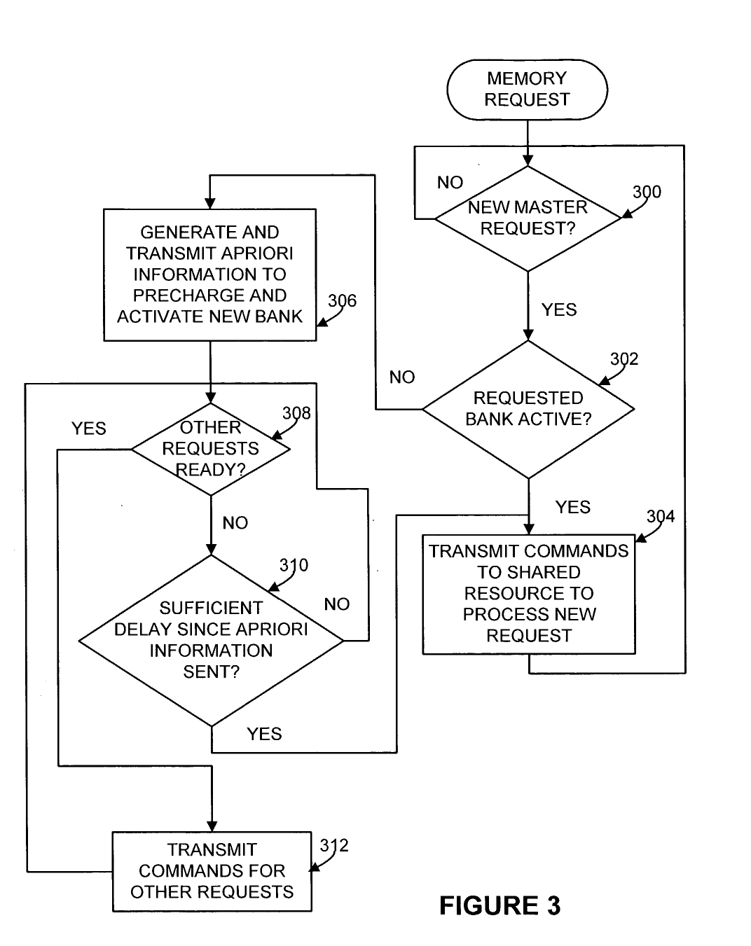

FIGS. 2 and 3 are flowcharts describing operation of the present invention as generally applied to any shared resource (FIG. 2) and as specifically applied to a shared memory controller (FIG. 3). Element 200 is first operable to await receipt of a new master request (i.e., a request for temporary exclusive access to the shared resource). Upon receipt of such a new request from a master device, element 202 is next operable to determine whether the shared resource is ready to process such a new request. If so, element 204 is operable to transmit commands associated with the newly received request to the shared resource for appropriate processing within the shared resource. Processing then continues by looping back to element 200 to await receipt of another new master request.

If element 202 determines that the shared resource is not yet ready to process the new request (i.e., not the optimal time to process the new request), element 206 is operable to generate and transmit apriori information useful to the shared resource to prepare for processing of the new request detected by elements 200 and 202. As noted above, such apriori information generally includes any and all information useful to the shared resource in advance of its receipt and processing of the new command sequence to enable improved utilization of the shared resource while processing commands from multiple master devices.

Element 208 then determines whether other previously received master requests are now optimally processed by the shared resource. If so, element 212 is operable to transmit the delayed commands associated with a previously received master request to the shared resource for processing. If element 208 determines no other commands relating to prior master requests are ready for such processing, element 210 then determines whether a sufficient delay period has expired following the transmission of apriori information as discussed above with respect to element 206. If not, processing continues by looping back to element 208 to determine if other requests may be processed. If a sufficient delay period has expired following generation and transmission of apriori information for a newly received request, processing continues at element 204 to transmit the commands associated with the newly received request to the shared resource for further processing. Processing then continues by looping back to element 200 to await receipt of further new requests from master devices.

In general, the method of FIG. 2 suggests an imposed delay between receipt of a new master request and processing of commands associated with the new request. During the delay, apriori information is made available to the shared resource to permit the shared resource to optimize utilization thereof. In particular, such optimizations may include overlapping preparatory steps associated with processing of a new master request with operational steps associated with the transfer of data requested by the requesting master devices. By making apriori information available to the shared resource prior to processing of commands associated with a new master request, the shared resource is capable of applying optimization techniques to improve utilization of the shared resource.

FIG. 3 is an essentially identical flowchart making specific reference to application of the method to a memory controller as the shared resource. As noted above, memory controller devices adapted to control multiple banks of memory (especially SDRAM and other command oriented memory components) may benefit from receipt of apriori information indicative of anticipated changes in the presently active banks of memory controlled by the memory controller. Latency periods normally required between opening or activation of a particular bank and subsequent access to that bank are preferably overlapped with manipulation of data in other presently active memory banks. Structures and methods of the present invention as applied to such a shared memory controller resource permit the memory controller to provide such overlapping of bank switching latency with operation on behalf of other presently active memory banks.

Elements 300 through 312 of FIG. 3 are operable substantially as described above with respect to FIG. 2 (element 200 through 212). Of note is the operation of element 300 to await receipt of a new master request identifying a memory bank required for processing of the new request, operation of element 302 to determine whether the memory bank associated with the newly received request is presently active, and processing of element 306 to generate and transmit apriori information indicating need for precharge and activation of the new bank of memory. Similar to FIG. 2, FIG. 3 generally describes a process whereby a delay is imposed between receipt of a new memory request and transmission of commands associated with processing that request. During this delay, apriori information regarding the need for a memory bank activation is generated and transmitted to the shared memory controller along with commands for other, previously received and sufficiently delayed master requests.

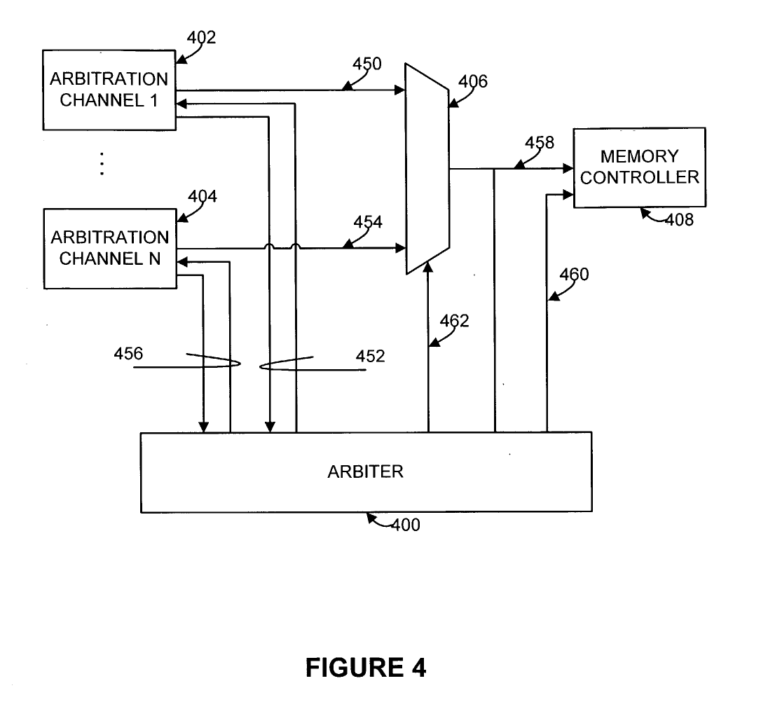

FIG. 4 is a block diagram of an exemplary preferred structure implementing the present invention as applied to shared memory controller 408. Arbiter element 400 receives requests for access to shared memory controller 408 from each of a plurality of arbitration channels. In particular, arbiter 400 receives requests from arbitration channel 402 via path 452 and, when appropriate, returns an associated grant signal via path 452. In like manner, arbiter element 400 receives requests for access to memory controller 408 from arbitration channel 404 via path 456 and returns, when appropriate, and associated grant signal also via path 456. When appropriate in accordance with the arbitration techniques implemented within arbiter 400, a selection signal applied via path 462 to multiplexer 406 permits the channel (402 or 404) granted access through arbitration to apply its commands via path 450 or 454, respectively, through multiplexer 406 onto path 458 for application to memory controller 408.

Numerous design choices will be apparent to those of ordinary skill in the art for associating a memory bank with a channel's request directed to the arbiter. One exemplary technique and structure for associating a memory bank with a channel request is presented in the second sibling patent application noted above and incorporated herein.

When arbiter element 400 detects a new master request from an arbitration channel, appropriate apriori information indicating the desired memory bank switch will be generated and applied via path 458 to memory controller 408 in conjunction with other memory commands associated with other presently active banks and generated by other arbitration channels coupled to arbiter element 400. The particular apriori information generated is preferably bank active and page hit information based on the command stream sent to the memory controller for each newly received master request. In addition, a command write signal generated by arbiter element 400 is applied to memory controller 408 via path 460 to permit control by the arbiter of clocking of commands to the memory controller. The command write signal is asserted by arbiter element 400 when the command is to be passed through from the arbitration channel presently granted access to the memory controller or when the arbiter is generating a priori information applied to command path 458 as precharge or activate information.

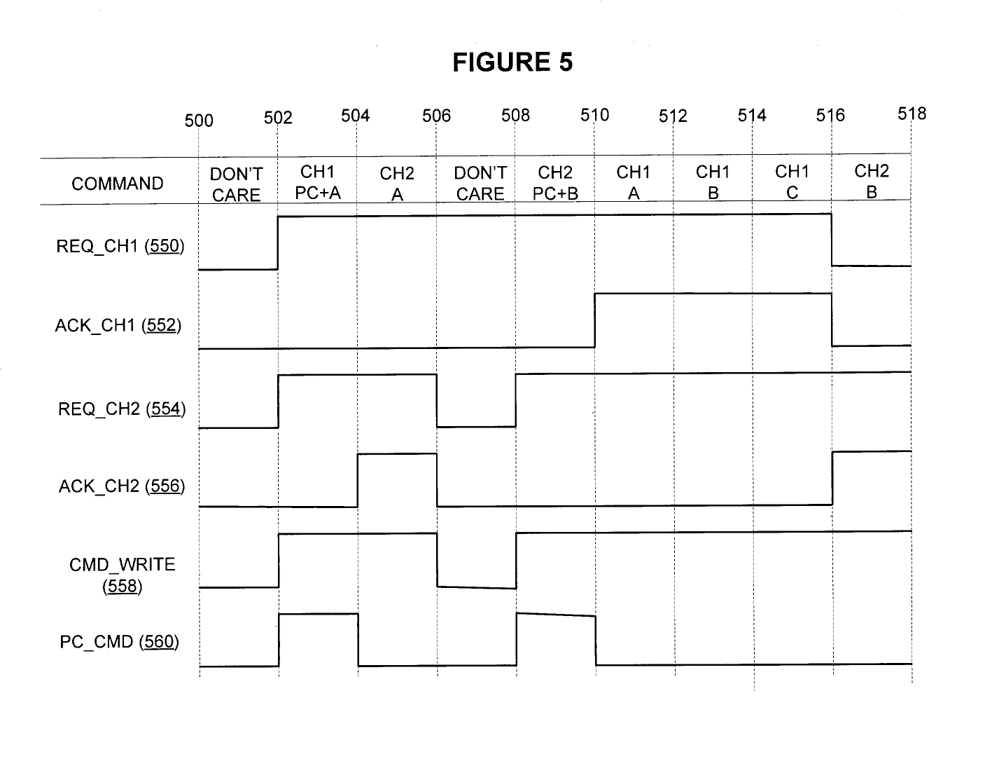

FIG. 5 is an exemplary timing chart representing typical request and command sequences generated by two arbitration channels coupled to the arbiter as shown, for example, in FIG. 4 above. In the timing diagram indicates time is increasing left to right with relevant time indicators marked as references 500 through 518. Typical signals are shown in rows from left to right and include: request for channel 1 (550), acknowledgment of request for channel 1 (552), request for channel 2 (554), acknowledgment of request for channel 2 (556), commanded write (558), and precharge command (560). Further, near the top of FIG. 5 each column corresponding to an associated timing designation indicates the command (if any) applied to the memory controller by an arbitration channel granted temporary access to the memory controller or by the arbiter itself applying apriori information in the form of precharge or activate command sequences.

At time indicator 500, all signals are presently inactive (de-asserted in accordance with the logic chosen by the designer). Such a state indicates no outstanding request from either exemplary master device. Accordingly, no command need be applied to the memory controller. At time indicator 502 both channel 1 and channel 2 master devices request access to the shared memory controller as indicated by request for channel 1 (550) and request for channel 2 (554) both being asserted active high. The arbiter will understand that a command “A” is to be applied to the memory controller on behalf of channel 1 and a command “A” is to be applied to the memory controller on behalf of the master device on channel 2. Prior to granting either request, also at time indicator 502, the arbiter element applies a precharge command corresponding to the bank requested by command “A” by the master device associated with channel 1. In addition, command “A” requested by a master device on channel 2 is applied to the memory controller. Hence, precharge command signal 560 and command write signal 558 are both shown asserted high.

At time indicator 504, the master device associated with channel 2 is granted its requested access to the shared memory controller as indicated by the assertion active high of acknowledgment of request for channel 2 (556). Further, at time indicator 504, precharge command signal 560 is de-asserted. The memory controller will therefore initiate preparatory activities (precharge and activate) for the memory bank associated with the request for channel 1 while overlapping processing of commands associated with the granted request for channel 2. It will be noted that the request signal for channel 1 (550) remains pending active high. A first command (“A”) is also issued on behalf of the request for channel 2.

At time indicator 506, the request for channel 2 (554) is de-asserted in recognition of the acknowledgment received on signal path 556. Further, the command write signal 558 is de-asserted because no command is presently ready for application to the memory controller. Rather, processing for channel 1 is deferred because channel 2 presently has been granted access to the memory controller and processing for the request associated with channel 2 is delayed until the bank of memory required is ready for processing. At time indicator 508, a precharge command (“B”) is inserted in the command stream to the memory controller requested by channel 2. Hence, preparatory processing for command “B”: on behalf of the master device associated with channel 2 may overlap processing of command “A” on channel 1. Further, preparations for processing of command “A” requested by channel 1 could have overlapped prior command cycles due to the precharge command added to the command cycle at time indicator 502 discussed above. Still further, the precharge command issued here at time indicator 508 for future processing of command “B” requested by channel two may generate preparatory processing in the memory controller overlapping processing for command “A” on channel 1. Later, at time indicator 516, when the master device on channel 2 is again granted control of the memory controller, the preparatory processing enabled by the precharge command at this time indicator 508 may permit improved memory utilization of the memory subsystem. Those of ordinary skill in the art will recognize that the signal timings and relationships of FIG. 5 are intended as merely indicative of exemplary signal timing relationships that may achieve the desired overlap of preparatory processing within a memory controller enabled by the apriori information supplied by the arbiter to the memory controller in advance of the actual command transmission for a particular request. Those of ordinary skill in the art will recognize a number of similar timing relationships among signals appropriate to a particular application to provide apriori information to the memory controller to enable overlapped processing and resultant improved bandwidth utilization.

While the invention has been illustrated and described in the drawings and foregoing description, such illustration and description is to be considered as exemplary and not restrictive in character, it being understood that only the preferred embodiment and minor variants thereof have been shown and described and that all changes and modifications that come within the spirit of the invention are desired to be protected.

What is claimed is:

1. A method operable in an arbiter coupling a plurality of master devices to a memory controller controlling multiple banks of memory, said method comprising:
detecting a pending request from a first master device to issue first commands to said memory controller;
generating apriori information regarding said first commands; and
applying said apriori information to said memory controller in advance of applying said first commands to said memory controller to enable said memory controller to prepare for future receipt of said first commands.

2. The method of claim 1 wherein the step of applying comprises the step of:
applying said apriori information in conjunction with application of other commands to said memory controller.

3. The method of claim 2 wherein the step of generating comprises the step of:
generating apriori information indicating a change in presently accessed memory bank when said first commands relate to a first bank of memory and wherein said other commands relate to a different bank of memory.

4. The method of claim 3 further comprising:
delaying application of said first commands to permit said memory controller to prepare said first bank; and
applying said other commands related to said different banks to said memory controller during the period of delay.

5. The method of claim 4 wherein the step of generating apriori information indicating a change in presently accessed memory bank comprises the steps of:
generating a precharge command for said first bank of memory; and
applying said precharge command in advance of application of said first commands.

6. A method operable in an arbiter coupling a plurality of master devices to a shared resource to optimize utilization of said shared resource, said method comprising the steps of:
detecting a first request from a first master device of said plurality of master devices for first commands to be applied to said shared resource;
generating apriori information regarding said first request wherein said apriori information is useful to said shared resource to optimize utilization thereof; and
transmitting said apriori information combined with other commands to said shared resource.

7. The method of claim 6 further comprising:
detecting a second request from a second master device of said plurality of master devices for second commands to be applied to said shared resource,
wherein the step of transmitting comprises the step of:
transmitting said apriori information in combination with said second commands.

8. A system including a shared resource and a plurality of master devices, said system comprising:
an arbitration element for selecting a requesting master device of said plurality of master devices and for applying commands from said requesting master device to said shared resource; and
an apriori information generator for generating apriori information regarding a request by said requesting master device and for applying said apriori information to said shared resource in advance of the application of said commands to said shared resource by said arbitration element.

9. A system operable in an arbiter coupling a plurality of master devices to a memory controller controlling multiple banks of memory, said system comprising:
means for detecting a pending request from a first master device to issue first commands to said memory controller;
means for generating apriori information regarding said first commands; and
means for applying said apriori information to said memory controller in advance of applying said first commands to said memory controller to enable said memory controller to prepare for future receipt of said first commands.

10. The system of claim 9 wherein the means for applying comprises:
means for applying said apriori information in conjunction with application of other commands to said memory controller.

11. The system of claim 10 wherein the means for generating comprises:
means for generating apriori information indicating a change in presently accessed memory bank when said first commands relate to a first bank of memory and wherein said other commands relate to a different bank of memory.

12. The system of claim 11 further comprising:
means for delaying application of said first commands to permit said memory controller to prepare said first bank; and
means for applying said other commands related to said different banks to said memory controller during the period of delay.

13. The system of claim 12 wherein the means for generating apriori information indicating a change in presently accessed memory bank comprises:
means for generating a precharge command for said first bank of memory; and
applying said precharge command in advance of application of said first commands.

14. The system of claim 9 wherein said memory controller is a multi-ported memory controller and wherein each master device of said plurality of master devices is a bus coupled through said arbiter to a corresponding port of said multi-ported memory controller.
